(19) United States
(12) Patent Application Publication
(10) Pub. No.: US 2013/0162665 A1
(43) Pub. Date: Jun. 27, 2013

(54) IMAGE VIEW IN MAPPING

(71) Applicant: James D. Lynch, Chicago, IL (US)

(72) Inventor: James D. Lynch, Chicago, IL (US)

(21) Appl. No.: 13/332,718

(22) Filed: Dec. 21, 2011

(51) Int. Cl. G09G 5/377; G09G 5/02

(52) U.S. Cl. 345/589; 345/632

(57) ABSTRACT

Mapping or navigation incorporates a real-world view. A map representing a region as a first computer generated graphic is displayed. The map may alternatively be a satellite view. A route is indicated on the map. The route is a computer generated graphic. A real-world image of a view from a location or sequence of image from locations along the route is overlaid on the map, such as being in a small box on the map.

### BACKGROUND

The present invention generally relates to mapping. Maps are generated for navigation. Navigation systems or devices provide useful features, including the identification of routes to destinations or points of interests. The navigation system determines the route of travel from an origin to a destination. A database of locations (e.g., nodes) and streets (e.g., links) is used by the navigation system to determine the route. The navigation is presented to the user with a map.

The presentation to the user may include further information. A street view or panoramic view associated with a location may be displayed instead of the map. The panoramic view may include route information, such as a line graphic shown on a photograph of the street. However, this street view provides only local or directly viewable information. The user must toggle between the panoramic view and the map, resulting in greater inconvenience and bandwidth usage.

### SUMMARY

In one aspect, a method is provided, such as for viewing an actual image in mapping. A map representing a region is displayed as a first computer generated graphic. The map may alternatively be a satellite view. A route is indicated on the map. The route is a computer generated graphic. A real-world image of a view from a location along the route is overlaid on the map, such as being in a small box on the map.

The paragraph above represents one of various aspects. The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

FIG. 1 illustrates a flow diagram of one embodiment of a method for an image view in mapping.

FIG. 2 illustrates panoramic view selection, according to one embodiment.

FIG. 3 illustrates one embodiment of extraction of an image from a panoramic view.

FIG. 4 illustrates an example map with an overlaid real-world image.

FIG. 5 illustrates another example map with an overlaid real-world image.

FIG. 6 illustrates one embodiment of a combination real-world view and a map with an overlaid real-world view.

FIG. 7 illustrates a mobile device or computer for navigation or mapping with an image view, according to one embodiment.

FIG. 8 illustrates a system, according to one embodiment, for providing an image view in navigation or mapping.

### DETAILED DESCRIPTION OF THE PRESENTLY PREFERRED EMBODIMENTS

Street-level images are provided on a two-dimensional (2D) map instead of or in addition to a dedicated panoramic viewer. A simplified thumbnail display is provided for the street-level image on the map so that there is no need for a separate panoramic or street-level view.

In one embodiment, an image or sequence of images (video navigation) of a route are shown on the 2D map for better understanding of the geo-location of the images or video. The street-level images may be displayed with their geo-location and orientation on the map. The image may be updated as the user travels along the route, such as indicating what objects the user should be seeing from the location in their direction of travel. For use on a computer, the user may view street-side images by moving a cursor over the 2D map of any link that is on the route. For either application, the view direction may be to the side, forward, behind or other direction. The orientation of the image on the map to the a current location may rotate to show the direction from which the image is being viewed.

The image may show one or more positions of interest along the route. For example, the map includes a route. The image on the map is of a point of interest associated with a current location. Alternatively, one or more images are provided along a route in the map where each image shows points of interest within the map and/or along the route. Previously shown images may be persisted, such as continuing to display the last X (e.g., 5) images on the map.

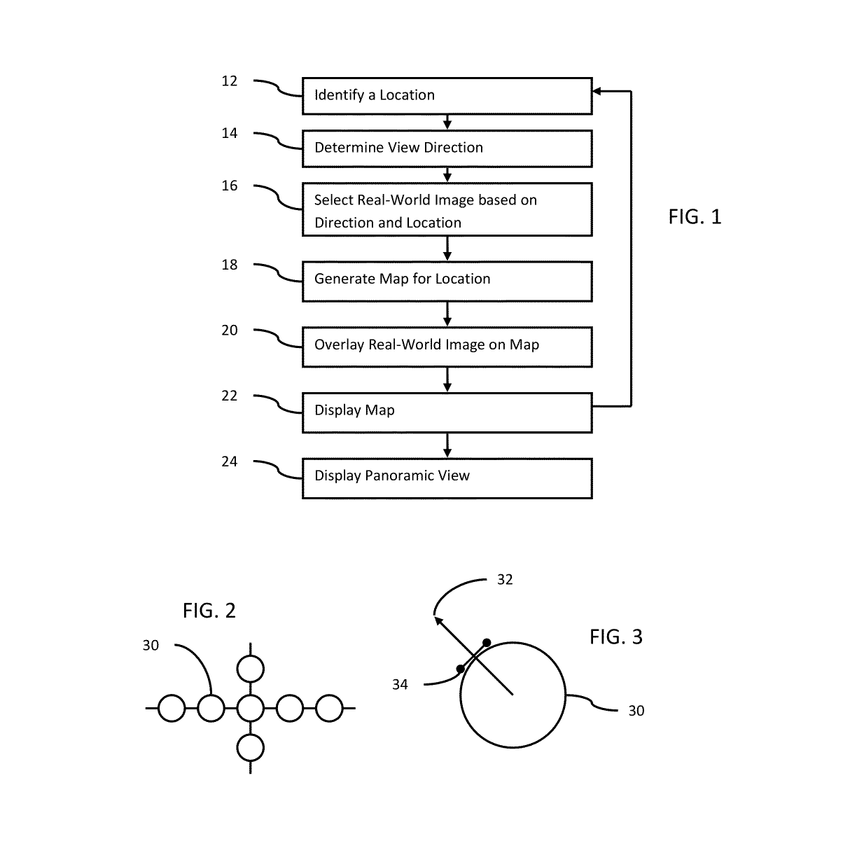

FIG. 1 shows a method for viewing an image in mapping or navigation. A real-world or street-level view presented on a map may assist the user.

Additional, different, or fewer acts than shown in FIG. 1 may be used. For example, act 24 is not performed. As another example, the overlay of act 20 is combined with the generation of the map 18 so that both are performed as one act. In yet another example, the map with the real-world image is stored or transmitted and not displayed in act 22. In another example, augmented reality information or other data may be additionally presented to the user.

The acts are performed in the order shown. Different orders may be used. For example, the display acts 22 and 24 may be reversed or performed simultaneously. As another example, the direction may be determined in act 14 prior to identifying the location in act 12. In another example, the map may be generated in act 18 before or after any of acts 12, 14, 16, or 20.

FIG. 1 is from the context of a mobile device or personal computer. A processor of the mobile device or computer applies an algorithm to identify the location, determine the direction, select an image, generate a map, overlay the map with the image, and display the map with the overlay. The image and/or map information associated with a given location may be downloaded to the mobile device or computer and stored for performing the acts. The display of the mobile device or computer presents the map with the overlay.

In other embodiments, some or all of the acts are performed by a server or processor associated with a collector of data, such as a mapping database/provider. The mobile device or computer may indicate the location and view direction based on positioning circuitry or user input. The server may perform one or more of the other acts. For example, the image is selected in act 16 by the server and transmitted to the computer or mobile device. Similarly, the map may be generated in act 18 by the server and transmitted to the mobile device. Likewise, route calculation may be performed by the server, mobile device, or computer. The overlaying may be performed by the mobile device or personal computer or may be performed by the server so that the transmitted map includes the overlay.

In act 12, a location is identified. The location may be entered by a user or may be the current location of a navigation device and the associated user. The location is coordinates in a world, region, or other frame of reference. Alternatively, the location is relative (e.g., 10 meters west of point of interest X). In alternative embodiments, the location is known, generalized to an area or region, or is not used.

In one embodiment, the location of a mobile device is detected. Positioning coordinates may be determined from a satellite system. A mobile device correlates spread spectrum signals form satellites to determine location, such as using the global positioning system (GPS).

Triangulation is alternatively used to determine the location. In triangulation, position circuitry includes a signal strength sensor or an array of signal strength sensors configured to measure the signal level from two or more antennas. The controller calculates the position of the mobile device from the signal strength measurements. Triangulation may be used in cellular networks, Bluetooth, or in wireless LAN and wireless mesh, as described in the IEEE 802.11 family of standards.

In addition or in the alternative to a signal strength sensor, the position circuitry may include a timer configured to measure the time necessary for a response from the network. The controller may estimate the position of the mobile device from the change in response times or by comparing response times from a plurality of antennas or access points.

In another example, proximity detection is used to determine location. A plurality of antennas is configured into a grid or other pattern. The position circuitry detects the closest antenna and the controller estimates the location of the mobile device. Proximity detection is limited by the density of the pattern of antenna. However, inexpensive technologies, such as radio frequency identification (RFID), are suited for dense grids of antennae.

The position circuitry may include relative position sensors in an inertial position system or dead reckoning system. Relative positions sensors include but are not limited to magnetic sensors (e.g., magnetometers, compasses), accelerometers, gyroscopes, and altimeters. Magnetic sensors determine the direction and/or strength of a magnetic field and can be used to determine heading or orientation. Inertial sensors, such as accelerometers and gyroscopes, measure acceleration, which can be used to calculate position, orientation, and velocity (direction and speed of movement) of the mobile device. An altimeter is a pressure sensor used to determine the relative altitude of the mobile device, which may be used to determine the vertical location of the mobile device.

In another embodiment, the location is entered by the user. The user of a mobile device or personal computer may enter an address or select a location or link associated with a location. For example, the user is presented with a map or navigation user interface. The user selects a location by placing a cursor or typing in a location. The location may not be of a particular device, but is instead a location of interest to the user.

The location may be associated with a route, such as a route for navigation. The user of a mobile device or personal computer may indicate beginning and ending locations. The mobile device, personal computer, or server determines a route between the two locations. The route may rely on different types of transportation, such as being a walking, driving, or boating route. The route may be determined based on shortest distance, shortest time, or other criteria. The route may be formed as a series of nodes, such as locations associated with intersections, and a series of links or segments, such as streets between nodes.

The route represents a collection of locations between and including the beginning and ending locations. Based on a current position of a user and mobile device or based on a user selection, one of the locations along the route is identified. Alternatively, processor-based or automatic selection of a location along the route may be provided. For example, a point of interest along the route is identified and information for the corresponding location is to be presented to the user.

The location may be selected in response to other criteria. The location may be for points along a route, such as navigation turns. One or more locations may be of interest, such as providing images at each turn along a route to assist in navigation. The location may be selected as any landmark, significant building, or interesting feature within the region of the map. For example, the location may correspond to a store of interest in general or to a particular user, such as a location of a closest Starbucks or all Starbucks on the map.

In act 14, a view direction is determined. A processor determines the view direction. The processor receives data from sensors or user input. From the received data, the direction of the view from the location is determined. The processor determines a compass heading or other direction indication from the location identified in act 12. In an alternative embodiment, the direction is not determined and the camera view is merely used as the real-world image selected in act 16.

In one example, an orientation sensor or compass indicates a direction to which a mobile device is pointing. The direction of the user's point of view may alternatively or additionally be determined, such as determining facial orientation relative to a camera imaging the user. An image from a camera on the mobile device may be compared to a reference database of such images or building layout (e.g., LIDAR data) and used to determine a direction to which the mobile device is facing.

As another example, a direction of travel is determined along the route. As the location of the mobile device changes, an indication of direction along the route is provided. The indication of beginning and ending points may indicate the direction of travel along the route. The current link and direction indicate the direction of view, such as traveling north on a north-south street indicating a northward view.

In another example, a user indication of a direction based on a cursor position, numerical entry, or other selection is received. The user selects the view direction based on any desired criteria. The selection may be a predetermined setting, such as setting the direction to always be in a particular direction with or without reference to any route. The selection may be in real-time or based on the user's current entry. The view direction may be defined as a vector between a user cursor and a closest point to a road link from the cursor or closest point to link along a specific route. The view direction may also be defined based on user cursor interaction with map attributes, such as building footprints or map points of interest. For example, the user clicks anywhere within a building footprint and the image is created to look at the center of the building with a field of view such that the entire building is visible.

In act 16, a real-world image is selected. The real-world image is a photo from an optical camera or is a frame from a video. The real-world image may be free of computer generated graphics other than such graphics being displayed in the real world when the image is captured. Alternatively, the real-world image may include graphics overlays, such as added lines or icons. The real-world image has any resolution, field of view, or scale. The real-world image may be black and white or color. The real-world image may have been or be processed, such as altering color, enhancing edges, filtering for noise, or other image processing.

The processor selects the real-world image using the view direction, field of view, and/or the location. The real-world image is selected from a collection other real world images. For example, different images are associated with different locations. FIG. 2 shows seven images, represented as circles, along two roads, represented as lines. The location identified in act 12 is used to select the image. The image closest to the location is selected, such as the image 30 in FIG. 2. Alternatively, an image for a location predicted to be closer at the time of display may be selected so that the displayed image corresponds with the view when displayed.

The image is of the surroundings. For a given field of view, the image is of one or more structures adjacent to or viewable from the location. The view or scene is not a substantially real time scene, but, instead, the view or scene is one or more stored images or video, such as a street view found in map applications.

The image may be selected as an extract from a larger image. The field of view may be reduced. The larger image may be subsampled or decreased in resolution. Any field of view criteria may be used, such as using a wider angle for buildings and a narrowing angle for store front selections. The size of the overlay on the map may vary based on the field of view or is fixed. The view size or field of view (FOV) may be controlled based on distance of cursor from a road link. The field of view may be defined based on user cursor interaction with map attributes, such as building footprints or map points of interest. For example, the user clicks anywhere within a building footprint and the image is created to look at the center of the building with a field of view such that the entire building is visible. Alternatively, if a point of interest is selected from the map, the field of view may be narrower

In the example of FIG. 2, each image is associated with a 360 degree or lesser arc in a panoramic view. A panoramic view is available for each of various locations. After identifying the panoramic view closest to the location as shown in FIG. 2, a portion 34 of the panoramic view is selected as shown in FIG. 3. The portion corresponds to a sub-arc of the panoramic view. Any size sub-arc may be used, such as 90, 45, or other number of degrees or less. The sub-arc is positioned or centered about the view direction 32 determined in act 14. The view direction 32 indicates the location of the sub-arc or which portion of the panoramic view to select.

The selected portion of the panoramic view is used as extracted or further processed. For example, the selected portion 34 may be warped or processed to remove the fish eye or panoramic distortion, resulting in an image appearing more flat, as represented by the straight line of the portion 34. In alternative embodiments, one or more images without a panoramic view are provided for each location.

The selection of the image may include a selection of scale. Since the real-world image is to be displayed on a map, a smaller scale may be desired. The scale is set as appropriate for the size of the display. Only a portion of the selected image is selected for display. Alternatively or additionally, the selected image may be down sampled, decimated or otherwise have the resolution altered. In one example, the scale may be selected based on user input. The user indicates a size of the image on the map for any future or current use. The size indicates the scale. Alternatively, the scale may be dynamic. The user positions a cursor closer to or further away from a current location on the map. As a result, the scale and corresponding size of the images as displayed change.

The images to be used for selection are maintained in a database. Millions or other numbers of geo-referenced images are stored. The database is populated to be queried by the geographic location. The images are linked with the geographic location in a mapping or other database. If the database is a mapping database, the images may be linked to nodes or specific locations. The images may be linked to links, segments, and/or distances from nodes. If the images are stored in a separate database, the images are linked by geographic location or point of interest identification for later queries.

In an alternative embodiment, the image is selected as an image currently being acquired. A mobile device or camera associated with the mobile device captures an images or a sequence of images in a video. The captured images are selected.

In act 18, a map is generated. The map is a two-dimensional graphic of a region. The graphic shows structures as lines and/or shading, including streets and any buildings. The graphic is not a real-world view, but is instead a representation. The map may be a road map, a bike map, a pedestrian map, a floor map, or other map. In alternative embodiments, the map is a satellite or other overhead view. The map includes a real-world view as if seen from above. Streets or other points of interest may be graphically overlaid on the overhead view. The graphics are generated by a processor to represent real-world structure, but are symbols without being actual images. For example, a line or generally parallel lines represent a street. “Generally” may account for changes in the number of lanes or other deviations resulting from representing real-world structure with graphics.

The map is a two-dimensional representation. The map may not show elevation. Alternatively, elevation lines or other representation of elevation is included. In alternative embodiments, the map is from a street level perspective. In an overhead perspective, the view direction is vertical. In a street level perspective, the view direction may be generally horizontal. “Generally” accounts for hills or elevation away from orthogonal to gravity. For street level perspective, the map may have a smaller scale, representing streets and buildings viewable by a person at the location in the street. Such street-level maps are graphically generated. In other alternatives, any perspective may be used with a three-dimensional representation for the map. The structures represented in the map are modeled in three-dimensions.

The map is generated from a database. For example, the map is generated from a database of nodes and links or segments. Other formats may be used. The scale of the map is selected to indicate the size of the region represented by the map. The scale indicates which nodes and links to acquire for any given map. The location may be used to determine the region, such as centering the location on the map or positioning the location at a non-centered position of the map. The route may be used to orient the map so that, given a scale, as much of the route as possible is shown on the map. Any now known or later developed map generation may be used.

The map shows the route. The route is represented as a graphic. For example, a colored, bold, or wide line representing the route is formed on or as part of the map. For driving or other navigation, the route may be along one or more streets. In an alternative embodiment, a route is not shown on the map.

For navigation, the map with a route is useful in guiding a user to a location. In a computer application, the map with the route information may be used for trip planning. Links may be provided on the map for viewing images associated with a given location. Rather than transitioning the user away from the map, the selected real-world image may be displayed on the map. The user may benefit by having both the geo-location reference information provided by the map and the verification of current location provided by the real-world image during navigation along the route or without further user interaction. In mobile devices where switching between view modes is more difficult, the image on the map may be more convenient. It is useful to offer a view where the user does not need to switch between views.

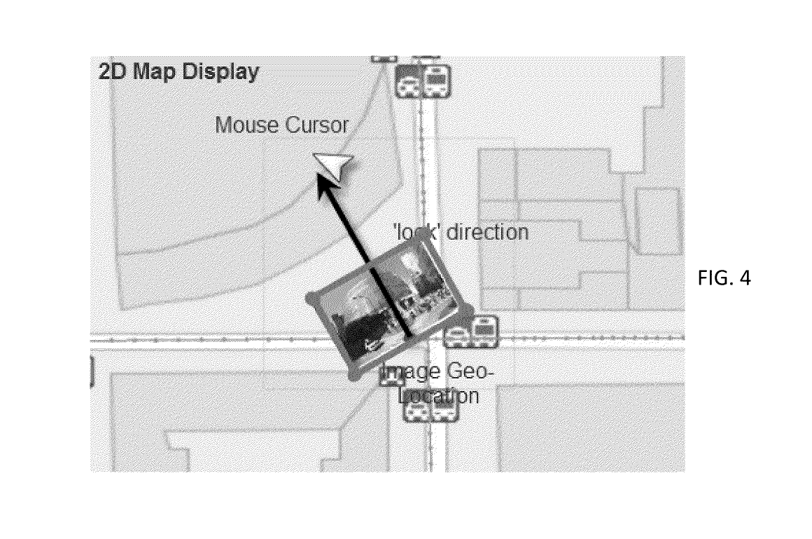

In act 20, the real-world image is overlaid on the map. The selected real-world image is formatted to fit in a box or other shape for display on the map. The shape may be circular. The shape may be a torus or group of boxes showing views from different or all directions. A graphic, such as a box is formed around the image. Alternatively, the image is overlaid without a graphic. The image may cover the map or may be semi-transparent so that the map features are visible through or with the image. Other graphics may be added, such as an arrow indicating the direction of view determined in act 14 (see FIG. 4). The overlay for the map includes the real-world image showing an actual view of one or more objects from the location determined in act 12.

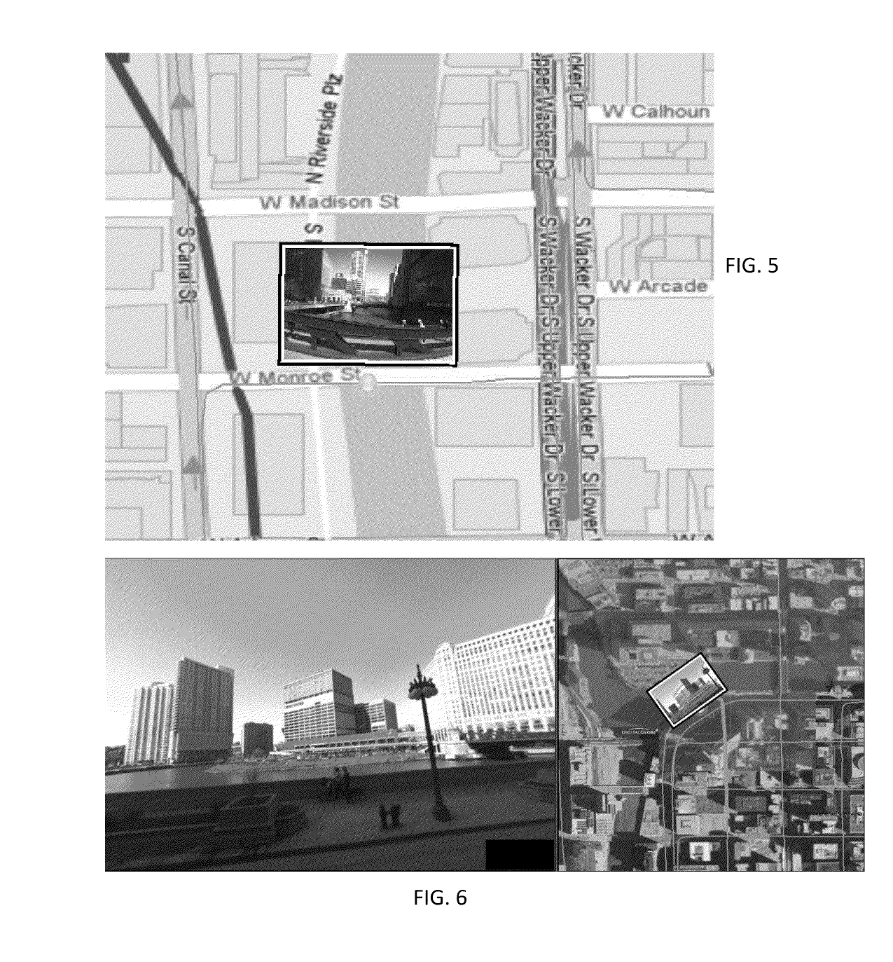

The overlay is laid over the location, positioned adjacent to location, or spaced from but graphically or conceptually associated with the location in the map. For example, FIG. 4 shows the overlay with the location at an edge of the overlay. As another example, FIG. 5 shows the overlay adjacent to but not touching or not over the location, represented as a circle. In another example, FIG. 6 shows the overlay with the location within the overlay.

Where the location is along the route, the overlay may be adjacent to or over the route. For example, the overlay is always adjacent and never covers the route. The overlay is adjacent to the colored line representing the route. In one embodiment, the overlay covers the route at a position on the map that has already been traveled or at a position to be traveled upon. The user may change the position of the overlay relative to the location and/or the route. The relative position may be constant during navigation or may change due to change in direction of travel, based on points of interest, or based on user input.

The overlay is oriented on the map. The orientation may be based on the view direction. For example, the overlay is oriented by rotation about the location based on the view direction. Where the view direction is constant, the orientation on the map remains constant even with change in location. Where the view direction changes, the orientation may change. For example, FIG. 4 shows a cursor used to indicate the view direction relative to a location. The overlay is oriented to be centered about the view direction on a side of the location close to the cursor. The image in the overlay is also oriented in this manner. If the user moves the cursor to the opposite side or other location at a different angle to the location, the overlay similarly rotates and the displayed image content shows the corresponding side of the street. In the opposite side example, the overlay flips about the location. The image is updated to show the different view given the new view direction.

In one navigation embodiment, the orientation of the overlay is based on the route. The orientation is along the direction of travel along the route for the current location. As the direction changes, such as due to turning a corner, the overlay also rotates to be along the direction of travel. The corner transition may be gradual or instantaneous. In other embodiments, the orientation stays the same despite changes in the direction of travel, such as always showing a view at a particular compass heading.

The overlay has any size. To provide the geo-location information with the map, the overlay may be 25%, 20%, or less of the area of the map. In one embodiment, the real-world image is overlaid on less than 10% of the map. FIGS. 4-6 show different relative sizes for the real-world image.

The overlay is in the map, so is bordered by the map. At least two sides of the overlay border or are beside the map. For example, the overlay is in a corner of the map, so two sides of a rectangle overlay are by the map and two sides are by a map border, screen edges, or other non-map part of a display. The overlay may be along an edge of the map so that three sides of the rectangular overlay are adjacent the map. In other embodiments shown in FIGS. 4-6, the overlay is surrounded by the map. Four or all sides of the overlay are adjacent to the map. The overlay is sized, shaped, and/or positioned to be incorporated into the map rather than being a separate image displayed adjacent to the map. The overlay takes space that would otherwise be displayed as part of the map.

In act 22, the map with the real-world image overlay is displayed. A representation of a geographical region is displayed with an actual image as viewed from a location in the geographical region. The map includes a graphical model of roads (such as Fake Rd., Green St., Blue Ave., Airport Rd., 2^{nd} St., Main St., 1^{st} St., Maple Ave, and/or other roads or paths), points of interest (such as an airport, a park, or a building), and/or other geographic or map features. The map is or is not photo/video imagery data. For example, the map is a vector-based, tile-based, or other type of computer generated, graphical map model or representation. The roads in the map are displayed based on map data, such as a road segment and corresponding nodes, created by a map developer. Graphical representations of the map are generated and/or displayed based on such map data.

The region is based on the user entered or device actual location. For example, the map of a current position of the user is displayed on a navigation device of the user. As another example, the region is based on an address or point of interest entered by a user on a personal computer. Entry may be for a destination, origination, or a point of interest. Using a user interface, the region may change. For example, the position of a cursor is used to re-determine a region, zoom in or zoom out. The location for the real-world view may be based on a current location of user or device or a user indicated position, such as a position of a cursor on a computer.

The real-world image portion of the map provides further information, such as a view from a location in the map. The view is from a different perspective and provides additional information. The map indicates geo-location information for the region, and the real-world image indicates the view from a given location in the region. The user may determine where they are going, where they have been, and information about surrounding areas not otherwise viewable by them. In addition, the real-world image provides confirmation to the user at that location of what they are seeing (e.g., photo-based confirmation that they are at the correct location) and/or information about the view from the location.

In act 24, a panoramic view may be displayed adjacent to the map. The panoramic view is the same as the real-world view of the overlay. Alternatively, the panoramic view is of a larger field of view, at a different scale, from a different location, and/or at a different direction. The panoramic view is from a perspective of someone viewing from the location in the geographic region rather than an overhead view.

The panoramic view is adjacent to the map, such as bordering the map along one side. FIG. 6 shows the panoramic view and the map displayed as the same size and side-by-side. Different relative sizes may be used. The map with overlay and panoramic view may be spaced apart or have other arrangements.

The display of a real-world image in an overlay on the map is combined with a 360 panoramic, street view, or other interface. The 2D map image complements the 360 display by providing reference geo-location and orientation in world space. The orientation of the overlay or real-world image assists the user in understanding the view of the panoramic image. When rotating the view in the panoramic interface, the overlay of the real-world image is similarly rotated. Instead of just showing a standard ‘push-pin’ marker on the two-dimensional map, more information is provided on the map by showing both the image at its geo-location and the direction.

FIG. 1 shows a loop back from act 22 to act 12 for repeating one or more of the acts between and/or including acts 12 to 22. In alternative embodiments, the loop back is from act 24. Any number of the acts may be repeated. The repetition may be for navigation. The navigation is in the mapping sense, such as traveling while tracking position. Alternatively, the navigating is in the computer sense, such as the user navigating a user interface to enter or indicate a different location.

In one embodiment, the identifying of act 12, selecting of act 16, and the displaying of act 22 are repeated. The same map, view directions, and overlay position on the map are used for an updated real-world view from a different location. In other embodiments, the location stays the same but the direction changes to update the real-world view. The view direction is constant or changes. For example, the view direction is the same regardless of direction of travel. As another example, the view direction is along the direction of travel, so changes as the direction changes.

In another embodiment, the location changes as a device or user travels. The viewing direction changes during the travel, such as due to the user traveling in a different direction (e.g., turning). The map updates to be for an overlapping region such that part of the previous region is not displayed, part is displayed, and a new portion of region is added. The overlay stays in the same location at the same size on the screen, but is over or at a new position on the map (e.g., adjacent to the current location of the user or device). The real-world image is selected for the new location and/or new view direction. As the user travels along the route, the location changes. The change in location results in a new real-world view. The view along a route may be previewed or seen in real-time on the map. For example, images or video of the view from locations on a two-dimensional map are selected based on a pre-defined destination route. The selected images or video is displayed from the map. The image thumbnail moves along the two-dimensional map. If a panoramic view is also provided, such as shown in FIG. 6, the panoramic street level imagery is also updated based on the progress along the route.

The real-world images may be pre-computed and delivered as a sequence of positioned images or as a video steam. The images are then displayed in the 2D map in sequence and with their position and orientation on the map updating. The overlay changes position and orientation as the corresponding view being displayed changes. A travel video moves on the map. Alternatively, the video is displayed in the overlay, but without the overlay moving relative to the map and/or the display screen.

For use with a computer or mobile device with a user interface for selecting locations on a screen, the repetition may be in response to a user changing a cursor position relative to a displayed map. FIG. 4 shows an example. Real-world images are displayed based on two-dimensional geo-location on the map at the mouse cursor. The user can view an interactive thumbnail of the street view by moving the mouse over the map. A fixed orientation (front, right side, left side, etc) is used. Alternatively, the image rotates to point toward the mouse direction from a set location or previous location.

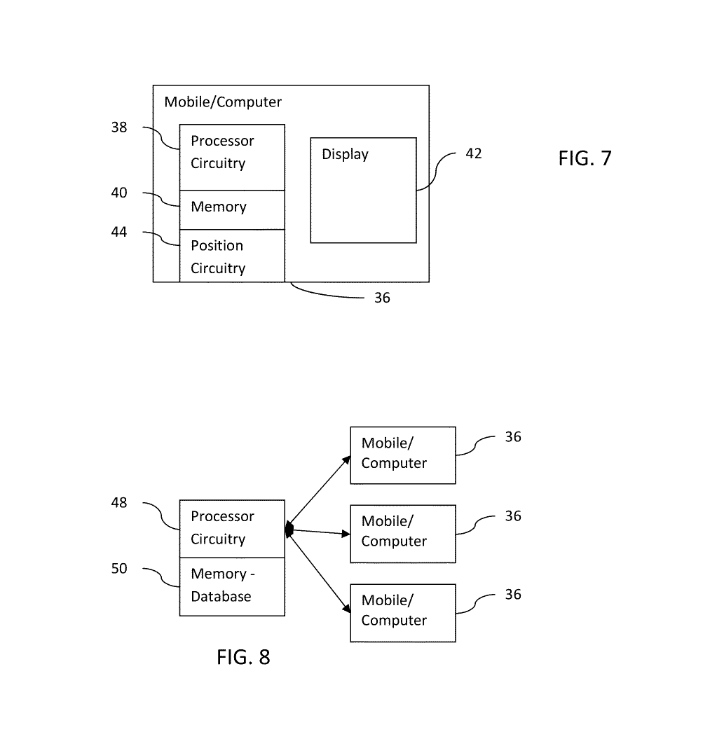

FIG. 7 illustrates an apparatus for image viewing in mapping. The apparatus is a mobile device or computer 36. As a mobile device, the apparatus is a cellular phone, mobile phone, camera, laptop, personal navigation device, portable navigation device, personal data assistant, computer, tablet, smart phone, or other handheld device capable of position sensing, map display, and/or navigation. The device may be carried with one hand, worn, or otherwise moved without assistance by others. As a computer, the device is a laptop, personal computer, desktop computer, tablet, server, workstation, or other computing device capable of accessing map information form the Internet or an intranet and displaying the map information.

The mobile device or computer 36 includes a processor or processing circuitry 32, a memory or database circuitry 34, a display 38, and position circuitry 44. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Additional, different, or fewer components may be provided. For example, the processor 32 is not provided or not used, instead relying on the image to be displayed on the display 38 being communicated from a remote server through a transceiver of the mobile device or computer 36. In yet another example, the mobile device or computer 36 includes an input device, camera, and/or a communication interface. The input device may be one or more buttons, keypad, keyboard, mouse, stylist pen, trackball, rocker switch, touch pad, voice recognition circuit, or other device or component for inputting data to the mobile device or computer 36. The input device and the display may be combined as a touch screen, which may be capacitive, resistive, or surface acoustic wave- based sensor. The display 38 may be a liquid crystal display (LCD) panel, light emitting diode (LED) screen, thin film transistor screen, monitor, projector, CRT, or another type of display.

The communication interface may include any operable connection. For example, the communication interface is a cellular transceiver for cellular communications or a wireless networking (e.g., WiFi) transceiver. An operable connection may be one in which signals, physical communications, and/or logical communications may be sent and/or received. An operable connection may include a physical interface, an electrical interface, and/or a data interface. The communication interface provides for wireless and/or wired communications in any now known or later developed format. The same or different communications interface may be provided with the processor 32.

One or more cameras, such as forward-facing and/or backward-facing cameras, may be provided. The mobile device or computer 36 or associated camera may be oriented to capture an image of the scene. The camera captures still and/or video images. A flash or flash circuitry may be provided. The camera captures an image for display of an actual view on the map. A still image or video of a scene is obtained using the camera, and then overlaid on a map. In other embodiments, the image or video is provided by the memory 40 rather than a camera.

As a mobile device, position circuitry 44 may be provided. The position circuitry 44 may include components for one or more of a variety of location algorithms. Other global navigation satellite systems, such as the Russian GLONASS or European Galileo, may be used. The Global Positioning System (GPS) is a satellite based system for reliable and accurate positioning but has limitations in indoor environments. However, GPS may be combined with or replaced by other location algorithms. Cellular or other positioning systems may be used as an alternative to GPS. In some implementations, the position circuitry may be omitted.

The memory 40 is a volatile memory or a non-volatile memory. The memory 40 includes one or more of a read only memory (ROM), random access memory (RAM), a flash memory, an electronic erasable program read only memory (EEPROM), magnetic, optical, or other type of memory. The memory 40 is configured as a cache, buffer, local, remote, removable media, hard drive or other computer readable storage media. The memory 40 may be removable from the mobile device or computer 36, such as a secure digital (SD) memory card.

In one embodiment, the memory 40 is a local memory. The memory 40 stores a map, such as a computer generated graphic, accessed or downloaded by the processor 38. The graphic has an overhead perspective. The view is as if looking down from a bird's eye direction on a region. The map represents the region. The memory 40 may store the geographical location of the mobile device or computer 36 and/or a direction input into or of the mobile device or computer 36. The stored map information may be based on the location and/or direction information. The map may include an indication of the location and/or route.

The memory 40 stores one or more actual views. Only actual views to be displayed are stored. Alternatively, a database of possible views is stored. For example, a panoramic view associated with a given location is stored for the processor 38 to extract the desired image. The memory 40 stores the actual view to be displayed as part of the map. The actual view is of an object or objects adjacent to a location. The object or objects may be natural (e.g., a tree, field, or lake) or may be man-made (e.g., a building, street, or bridge). The actual view is from a different perspective than of the map. The actual view is a side view perspective. The perspective is generally perpendicular to the overhead perspective, such as being generally horizontal. “Generally” accounts for looking upward or downward as if a person positioned at the location looked up or down.

The memory 40 may be a database memory. Geographic locations, point of interest information for points of interest, and images of the geographic locations are stored in the database. The database for the memory 40 of the mobile device or computer 36 may be a localized database, such as being for a region of operation of the mobile device or computer 36. For example, the information for locations within a threshold distance (e.g., kilometers) and/or up to a threshold amount of memory space is downloaded to the memory 40 of the mobile device or computer 36 for operation of the mobile device or computer 36. As long as the mobile device moves or indicated location is within the region associated with the downloaded data, the database is sufficient. If the mobile device or computer 36 moves to another region, additional or different data is downloaded and stored.

The database may be a map database, including map or navigation data used for navigation-related services. The map data may include segment and node information. Other formats may be used for the map data. In one embodiment, the map database may be produced and/or maintained by a map developer, such as NAVTEQ North America, LLC located in Chicago, Ill. The map database may include images, such as panoramic images for each of a plurality of locations associated with nodes or segments.

In one embodiment, the memory 40 is non-transitory computer readable medium configured to store instructions, executable by the processor 32, for displaying an actual view on a map. The instructions for implementing the processes, methods and/or techniques discussed herein are provided on the computer-readable storage media or memories. The computer executable instructions may be written in any computer language, such as C++, C#, Java, Pascal, Visual Basic, Perl, HyperText Markup Language (HTML), JavaScript, assembly language, extensible markup language (XML), shader languages (HLSL, GLSL), graphics languages (OpenGL), and any combination thereof. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination Likewise, processing strategies may include multiprocessing, multitasking, parallel processing, and the like. In one embodiment, the instructions are stored on a removable media device for reading by local or remote systems. In other embodiments, the instructions are stored in a remote location for transfer through a cellular network.

The processor 32 is a controller, general processor, digital signal processor, an application specific integrated circuit (ASIC), field programmable gate array, analog circuit, digital circuit, combinations thereof, or other now known or later developed processor/circuitry. The processor 32 may be a single device or combinations of devices, such as associated with a network, distributed processing, or cloud computing. The processor 32 may include or be connected with a communications interface. The processor 32 is part of the mobile device or computer 36.

The processor 32 is configured by software and/or hardware to communicate and display information for mapping. The processor 32 receives location information and communicates the location to a server. The processor 32 receives a map from or generates a map based on information received from the server. The processor 32 generates the map for display as a two-dimensional image. The map may include a location and/or route.

The processor 32 adds an actual view on the map. Alternatively, the actual view is received as part of the map from the server. The direction and other view information may be communicated to the server, and the actual view or map with the actual view received from the server. The processor 32 or the server determines where to position the actual view on the map, such as adjacent to or over a part of a route. The actual view borders the map on two, three, or greater number of sides, such as being a rectangular image surrounded on all four sides by the map.

The processor 32 is configured to regenerate the image. The image is replaced as the location or viewing direction changes. For different locations on the route, the regenerated images are of views of different objects. A person at different locations sees different things. The actual view or image is updated, even if the map does not otherwise change, as the location or direction of the actual or virtual user changes.

The processor 32 causes the display 38 to display the map with an included image. The image and map are from different perspectives, but are provided on a same screen. The image is further integrated into the map rather than or in addition to being provided separate from the map.

The functions may be distributed in various ways between the processor 32 and a remote server. The memory 40 may not include a database, so the processor 32 communicates information needed by the server to generate a display with a map and actual view overlay. The processor 32 then causes the server generated display to be displayed. The processor 32 alternatively receives the components of the display and forms the display. In other embodiments, the processor 32 constructs or acquires the components, such as selecting actual images from a database and/or forming the map.

FIG. 8 shows a system for actual view image in mapping. The system includes a processor or processing circuitry 52 and memory or database 54 as part of a server remote from one or more mobile devices or computers 36. The processor 52 and memory 54 are in a different room, different city, or otherwise spaced from the mobile devices or computers 36. For example, the processor 52 and memory 54 are part of a server providing navigation information to cellular phones or personal computers. The processing is shared between the remote processor 52 and any given mobile device or computer 36.

FIG. 8 shows the system as a network where the processor 52 and memory 54 operate with a plurality of mobile devices and/or computers 36. Each mobile device or computer 36 is operated by a different user at different locations. Additional mobile devices 36, and/or processors 52 and memories 54 may be provided.

The mobile device or computer 36 includes network interfaces for wirelessly or wired connection to the processor 52. The mobile devices communicate over a network. Any protocol or physical connection may be used to couple the processor 52 to the mobile devices or computers 36. The communication paths may utilize cellular (e.g., 3G, 4G, or WiMAX), Ethernet, wireless, or any Internet protocol technologies. Alternatively, the communications network may be a private network that may not be connected to the Internet, a peer-to-peer network, or an ad-hoc network, such as a mobile mesh network including mobile devices and wireless links. In other embodiments, one or more of the mobile devices or computers 36 are connected through a wire, such as USB cable.

In one embodiment, the remote processor 52 outputs a collection of database information to the mobile device or computer 36. The collection is part of a database. The processor 32 of the mobile device or computer 36 selects one or more actual view images from the collection. Differences in the location result in selection of different actual view images from the collection. The selected images are different for different users based on the location of the mobile device and the direction of view.

Various embodiments described herein can be used alone or in combination with one another. The foregoing detailed description has described only a few of the many possible implementations of the present invention. For this reason, this detailed description is intended by way of illustration, and not by way of limitation.

I (We) claim:

1. A method comprising:
identifying a location along a route;
determining, with a processor, a view direction from the location;
selecting, with the processor, a real-world image based on the view direction and the location;
generating a map showing the route;
overlaying the real-world image on the map;
displaying the map with the real-world image overlay; and
repeating the identifying, selecting, and displaying for different locations along the route such that the real-world image updates as the location along the route changes.

2. The method of claim 1 wherein identifying the location comprises identifying a current location of a user of a navigation device, wherein determining comprises determining an orientation of the navigation device, and wherein displaying comprises displaying on the navigation device.

3. The method of claim 1 wherein determining comprises determining a direction of travel as the view direction.

4. The method of claim 1 wherein determining comprises determining the view direction based on user selection of the view direction.

5. The method of claim 1 wherein the view direction is constant during the repeating.

6. The method of claim 1 wherein the view direction is at a constant angle to the route at each of the different locations.

7. The method of claim 1 wherein selecting comprises selecting a portion of a 360 degree view associated with 45 degrees or less about the view direction.

8. The method of claim 1 wherein selecting comprises selecting a scale for the real-world image, the scale selected as a function of a distance of a curser from the location on the map.

9. The method of claim 1 wherein generating the map comprises generating a two-dimensional road map graphic of a region represented by the map.

10. The method of claim 1 wherein overlaying comprises overlaying the real-world image surrounded by the map, oriented on the map in correspondence with the view direction, and covering less than 20% of the map.

11. The method of claim 1 wherein repeating is performed in response to user changing of a cursor position on the map.

12. The method of claim 1 further comprising displaying a panoramic view adjacent to the map.

13. In a non-transitory computer readable medium configured to store instructions, executable by a processor, the instructions comprising:
displaying a map representing a region as a first computer generated graphic;
indicating a route on the map, the route being a second computer generated graphic;
overlaying on the map a real-world image of a view from a location along the route.

14. The non-transitory computer readable medium of claim 13 wherein displaying the map comprises displaying a two-dimensional map for a region selected based on the location, the location comprising a current position of a user.

15. The non-transitory computer readable medium of claim 13 wherein displaying the map comprises displaying a two-dimensional map for a region selected based on a destination entered into a computer, and wherein the location is indicated by a position of a cursor of the computer.

16. The non-transitory computer readable medium of claim 13 wherein indicating the route comprises providing a colored line along one or more streets on the map, and wherein overlaying comprises overlaying the real-world image adjacent to the colored line on the map.

17. The non-transitory computer readable medium of claim 13 wherein overlaying comprises overlaying the real-world image surrounded by the map, oriented on the map in correspondence with a view direction, and covering less than 20% of the map.

18. The non-transitory computer readable medium of claim 13 further comprising updating the location during navigation along the map, the real-world image being updated with the location.

19. An apparatus comprising:
a memory having stored therein a map, a location on the map, a view of an object adjacent to the location, the view being from a different perspective than the map;
a processor configured to generate a two-dimensional image, the two-dimensional image comprising the view on the map with the map being on at least two sides of the view; and
a display operable to display the image of the view on the map.

20. The apparatus of claim 19 wherein the map comprises a computer generated graphic with an overhead perspective and wherein the view comprises side view perspective generally perpendicular to the overhead perspective.

21. The apparatus of claim 19 wherein the processor is configured to generate the two-dimensional image with a route on the map, the view positioned adjacent to or over a part of the route and being surrounded on all sides by the map and configured to regenerate the image for different locations on the route, the regenerated images comprising views of different objects as a function of the different locations.

22. The apparatus of claim 19 wherein the processor is configured to generate a sequence of the image on the map where the image is a moving video.
